(19) United States
(12) Patent Application Publication
(10) Pub. No.: US 2023/0295056 A1
(43) Pub. Date: Sep. 21, 2023

(54) Controlled release fertilizer containing ammonium polyphosphate and its preparation methods

(71) Applicant: Maoshi Agricultural Technology Co., Ltd., Chizhou (CN)

(72) Inventor: Chenghu Zhong, Chizhou (CN)

(21) Appl. No.: 18/140,459

(22) Filed: Apr. 27, 2023

(30) Foreign Application Priority Data
Feb. 28, 2023 (CN) 202310176067X

(51) Int. Cl. C05G 5/30; C05G 3/40; C05B 7/00

(52) U.S. Cl. CPC C05G 5/37; C05B 7/00; C05G 3/40

(57) ABSTRACT

A controlled release fertilizer containing ammonium polyphosphate includes fertilizer core particles and fertilizer envelopes coated on a surface of the fertilizer core particles respectively. P (phosphorus) is only from ammonium polyphosphate, and ammonium polyphosphate has a degree of polymerization in a range of 5 to 20. A preparation method of the controlled release fertilizer includes steps of (1) weighing the phosphorus source, the nitrogen source, the potassium source and the multiple metallic medium and trace element sources in the above weight parts, pulverizing, and obtaining powders by sieving through a sieve with a mesh number of 80; (2) preparing fertilizer core particles; (3) preparing polyurethane envelopes on a surface of the fertilizer core particles respectively, and (4) adding the agglomerant in the above weight parts into the fertilizer core particles coated with the polyurethane envelopes and cooling to 20° C.

### CROSS REFERENCE OF RELATED APPLICATION

The present invention claims priority under 35 U.S.C. 119(a-d) to CN 202310176067.X, filed Feb. 28, 2023.

### BACKGROUND OF THE PRESENT INVENTION

### Field of Invention

The present invention relates to the technical field of controlled release fertilizer, and more particularly to a controlled release fertilizer containing ammonium polyphosphate and its preparation methods.

### Description of Related Arts

Phosphate fertilizer takes phosphorus as the main nutrient. According to the solubility of phosphorous salt contained, the phosphate fertilizer is divided into three categories which are water soluble phosphate fertilizer, citrate-soluble phosphatic fertilizer and insoluble phosphate fertilizer. Monocalcium phosphate is the main component of water soluble phosphate fertilizer, which is soluble in water and has fast fertilization effect. Dicalcium phosphate is the main component of citrate-soluble phosphatic fertilizer, which is slightly soluble in water but soluble in 2% citric acid solution, and has slow fertilization effect. Tricalcium phosphate is the main component of insoluble phosphate fertilizer, which is slightly soluble in water and 2% citric acid solution and is able to achieve fertilization effect after being gradually changed into monocalcium phosphate or Dicalcium phosphate in the soil.

Modern phosphate fertilizer has been developed in accordance with the idea of “providing the best water solubility”, because water-soluble phosphorus is the most easily absorbed phosphorus by plants. However, the chemical properties of phosphorus are active, and phosphorus is able to be combined with various hypervalent cations in the soil to form complexes, which greatly reduces its solubility. On the other hand, colloidal particles in the soil are also able to be adsorbed with phosphate groups, so that water-soluble phosphate is able to be separated from the soil solution, and water solubility is lost, thus losing the quick effect on plants.

Another characteristic of water-soluble phosphorus in soil is that it is almost immobile in the soil, that is, it exists wherever the fertilization point is. Experiments show that in loamy-clay oil, the movement distance of water-soluble phosphorus is no more than 2 cm, and in sandy soil, the movement distance of water-soluble phosphorus is no more than 5 cm. Roots are not spread all over the soil, which also makes phosphorus difficult to be absorbed. From the perspective of fertilization, phosphate fertilizer should be evenly distributed in all parts of the soil as far as possible, so as to facilitate the absorption of plant roots. However, the wide spread of phosphate fertilizer in the soil obviously increases its fixation by the soil.

Due to the above characteristics, the utilization rate of phosphate fertilizer has been low, about 10-25%. That is, at least 75% of the phosphorus applied to the soil is not absorbed by plants, but is “fixed” in the soil in various ways. Although the fixed phosphorus is able to be slowly absorbed by crops later, this state is obviously unsatisfactory from the perspective of fertilization.

Polyphosphate phosphate fertilizer is a variety that appears to overcome the phosphorus fixation by soil. Polyphosphate is a polymer formed by the dehydration of orthophosphate under heating. Its general molecular formula is (NH4)ₙP₂ₙO₃ₙ₊₁. When n < 20, it is water-soluble and usually used as fertilizer. Ammonium polyphosphate is a kind of polyphosphate containing N and P, APP for short. Among them, agricultural ammonium polyphosphate is a kind of low N and high P polyphosphate, pH is nearly neutral, and its general chemical formula is (NH4)ₙ₊₂PₙO₃ₙ₊₁. According to the degree of polymerization, APP is able to be divided into oligophosphate, mesophosphate and polyphosphate. The higher the degree of polymerization, the lower the water solubility. In general, water solubility occurs when n<20.

In addition, medium and trace elements are essential for the growth of flowers and various crops. However, at present, there are few fertilizer products on the market that focus on nutrition. The domestic commercial fertilizer core generally only contains nitrogen, phosphorus and potassium, and lacks medium and trace elements. After coating, the effect of controlled release fertilizer is very different from that of imported total nutrition, so high-end controlled release fertilizer is basically monopolized by foreign imported controlled release fertilizer.

China Invention Patent CN 105777275A discloses a preparation method of polyphosphate fertilizer. The preparation method includes steps of (1) adding phosphate fertilizer and nitrogen fertilizer to the polymerization tank, forming polyphosphate by condensing at 170-250° C. for 0.5-1.5 hours; (2) directly granulating the slurry from the polymerization tank or granulating after the slurry is mixed with potash fertilizer; (3) cooling the granulated material, screening and packing to obtain the polyphosphate fertilizer. This preparation method optimizes the technological flow, solves the problem of pipeline blockage, and improves the production stability, and however, this polyphosphate fertilizer is a common fertilizer, which does not have the characteristics and advantages of controlled release fertilizer, and does not contain medium and trace elements, and the nutrients are not comprehensive.

China Invention Patent CN102295487A discloses an organic coated controlled release fertilizer and its preparation method. It is composed of the following fertilizer raw materials, urea 30-60, monoammonium phosphate 10-30, potassium salt 10-36, active organic matter 10, trace elements 0.02-0.1. The potassium salt is potassium sulfate, the active organic matter is active humic acid and active amino acid, and the trace elements are iron, manganese, zinc and copper. After the above raw materials are coated with oil coating agent, amino acids and trace elements such as iron, manganese, zinc and copper, which are necessary for crop growth, are added to the fertilizer to make a new compound fertilizer. However, the fertilizer core particles contain ammonium dihydrogen phosphate, which is easy to precipitate with trace elements, reduces the activities of phosphorus and trace elements, and is unable to be released from the coating, thus reducing the utilization rate of phosphorus and trace elements.

Therefore, it is urgent to develop a phosphate fertilizer with high utilization rate.

### SUMMARY OF THE PRESENT INVENTION

A technical problem to be solved of the present invention is to provide a controlled release fertilizer containing ammonium polyphosphate and its preparation methods, wherein the controlled release fertilizer comprises fertilizer core particles, the phosphorus in the fertilizer core particles only comes from ammonium polyphosphate; the controlled release fertilizer also contains nitrogen, potassium and multiple medium and trace elements, and is a fully water soluble slow-soluble long-lasting phosphate fertilizer. The controlled release fertilizer provided by the present invention is able to solve the problem not only the citrate-soluble phosphatic fertilizer is insoluble, but also orthophosphate and metal trace elements are prone to precipitation. After forming the polyurethane coating, both the phosphate fertilizer and the medium and trace elements are able to be slowly released from the polyurethane coating to improve the effective utilization of phosphorus and medium and trace elements.

Accordingly, in order to solve the above technical problem, the present invention adopts technical schemes as follows.

The present invention provides a controlled release fertilizer containing ammonium polyphosphate, wherein the controlled release fertilizer comprises fertilizer core particles and fertilizer envelopes coated on a surface of the fertilizer core particles respectively;
the fertilizer core particles contain phosphorus source, nitrogen source, potassium source and multiple metallic medium and trace element sources;
P (phosphorus) in the phosphorus source is only from ammonium polyphosphate, and ammonium polyphosphate has a chelating effect on metallic medium and trace elements in the multiple metallic medium and trace element sources.

The lower the degree of polymerization, the better the water solubility. Preferably, ammonium polyphosphate has a degree of polymerization in a range of 5 to 20.

Preferably, the multiple metallic medium and trace element sources comprise calcium source, magnesium source, boron source, molybdenum source, iron source, zinc source, manganese source and copper source.

Preferably, the controlled release fertilizer contains components in weight parts of:

| | |
|---|---|
| ammonium polyphosphate | 100-300 parts; |
| nitrogen source | 400-700 parts; |
| potassium source | 150-450 parts; |
| calcium source | 10-50 parts; |
| magnesium source | 50-100 parts; |
| boron source | 1-3 parts; |
| molybdenum source | 1-3 parts; |
| iron source | 5-20 parts; |
| zinc source | 0.5-1 part; |
| manganese source | 1.5-2 parts; |
| copper source and | 0.5-1 part; |
| an agglomerant | 5-30 parts. |

Preferably, the nitrogen source is ammonium nitrate phosphate, and more preferably is ammonium nitrate phosphate (30-6-0).

Preferably, the potassium source is potassium sulfate.

Preferably, the calcium source is potassium calcium magnesium sulfate.

Preferably, the magnesium source is at least one member selected from a group consisting of magnesium sulfate, magnesium nitrate and magnesium chloride.

Preferably, the boron source is at least one member selected from a group consisting of boric acid and sodium borate salt.

Preferably, the molybdenum source is at least one member selected from a group consisting of sodium molybdate and ammonium molybdate.

Preferably, the iron source is a mixture of EDTA (ethylenediaminetetraacetic acid) ferric salt and ferric nitrate, a mixture of EDTA ferric salt and ferric chloride, ferric nitrate or ferric chloride.

Preferably, the zinc source is at least one member selected from a group consisting of zinc sulfate, zinc nitrate and zinc chloride.

Preferably, the manganese source is at least one member selected from a group consisting of manganese sulfate, manganese nitrate and manganese chloride.

Preferably, the copper source is copper sulfate, copper nitrate or copper chloride.

Preferably, the fertilizer envelopes are polyurethane envelopes.

Also, the present invention provides a preparation method of the above controlled release fertilizer containing ammonium polyphosphate. The preparation method comprises steps of:
(1) weighing the phosphorus source, the nitrogen source, the potassium source and the multiple metallic medium and trace element sources in the above weight parts, pulverizing, and obtaining powders by sieving through a sieve with a mesh number of 80;
(2) preparing fertilizer core particles, which comprises thoroughly mixing the powders obtained by the step (1) in a granulator, introducing atomized water into the granulator through a nozzle, pelletizing, screening, polishing and drying;
(3) preparing fertilizer envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films till a coating rate is in a range of 1.9%-2.1%, and solidifying for 3 to 5 minutes, so that the polyurethane controlled release films are solidified into the dense and tough fertilizer envelopes, namely, polyurethane envelopes on the surface of the fertilizer core particles; and
(4) adding the agglomerant in the above weight parts into the fertilizer core particles coated with the polyurethane envelopes, and cooling to 20° C., thus obtaining the controlled release fertilizer containing ammonium polyphosphate, wherein the agglomerant is able to improve the strength and surface finish of the fertilizer core particles coated with the polyurethane envelopes, so as to avoid adhesion among the fertilizer core particles coated with the polyurethane envelopes, thus increasing rate of formation, reducing return grains, replacing clay and reducing overall cost.

The present invention has some beneficial effects as follows.

The controlled release fertilizer containing ammonium polyphosphate provided by the present invention includes fertilizer core particles, the phosphorus in the fertilizer core particles only comes from ammonium polyphosphate, the fertilizer core particles do not contain orthophosphate. Ammonium polyphosphate is fully water-soluble, so the controlled release fertilizer containing ammonium polyphosphate provided by the present invention is a fully water-soluble fertilizer, which is able to solve the problem not only the citrate-soluble phosphatic fertilizer is insoluble, but also orthophosphate and metal trace elements are prone to precipitation. After forming the polyurethane coating, both ammonium polyphosphate and the medium and trace elements in the fertilizer core particles are able to be slowly released from the polyurethane coating. Therefore, the controlled release fertilizer containing ammonium polyphosphate provided by the present invention is a slowly-soluble and long-acting phosphate fertilizer and has good fusion with plants, so that the effective utilization of phosphorus is improved.

In the controlled release fertilizer containing ammonium polyphosphate provided by the present invention, ammonium polyphosphate in the fertilizer core particles has a significant chelating effect on metal ions and is able to chelate with the added multiple medium and trace elements without precipitation. The present invention avoids the use of expensive chelating agents, thereby reducing the cost. After forming the polyurethane coating, the medium and trace elements are able to be slowly released from the polyurethane coating, so that the absorption and utilization rate of medium and trace elements is improved. The solubility of trace elements in ammonium polyphosphate solution is much higher than that in Ammonium orthophosphate solution, so the total nutrient of fertilizer is high.

For the controlled release fertilizer containing ammonium polyphosphate provided by the present invention, the medium and trace elements in the fertilizer core particles have wide sources, low price and high content. After forming the polyurethane coating, carbon and the trace elements are able to be slowly released from the polyurethane coating, which is able to better help crops supplement and strengthen the absorption and utilization of medium and trace elements, reduce the loss of elements in the absorption and transport process, so as to improve the absorption and utilization rate of medium and trace elements, and provide more comprehensive nutrition for crops.

### DETAILED DESCRIPTION OF THE PREFERRED EMBODIMENT

The present invention is further explained in combination with embodiments as follows. The following embodiments are only used to clarify the technical schemes of the present invention more clearly, and shall not be used to limit the protection scope of the present invention.

### First Embodiment

A controlled release fertilizer containing ammonium polyphosphate according to a first embodiment of the present invention is provided. The controlled release fertilizer comprises fertilizer core particles and fertilizer envelopes coated on a surface of the fertilizer core particles respectively, wherein the controlled release fertilizer contains components in weight parts of:

| | |
|---|---|
| ammonium nitrate phosphate (30-6-0) | 600 parts; |
| ammonium polyphosphate | 100 parts; |
| potassium sulphate | 220 parts; |
| potassium calcium magnesium sulfate | 10 parts; |
| magnesium sulfate | 50 parts; |
| boric acid | 1 part; |
| sodium molybdate | 1 part; |
| EDTA (ethylenediaminetetraacetic acid) ferric salt and ferric nitrate | 5 parts; |
| zinc sulfate | 0.5 part; |
| manganese sulfate | 1.5 parts; |
| copper sulfate and | 1 part; |
| an agglomerant | 10 parts, |

wherein ammonium polyphosphate has a degree of polymerization in a range of 5 to 20.

A preparation method of the above controlled release fertilizer containing ammonium polyphosphate comprises steps of:
(1) putting the above components except the agglomerant in the above weight parts into a pulverizer, pulverizing and obtaining powders by sieving through a sieve with a mesh number of 80;
(2) preparing fertilizer core particles, which comprises thoroughly mixing the powders obtained by the step (1) in a discal granulator, introducing atomized water into the discal granulator through a nozzle, pelletizing, screening, polishing and drying;
(3) preparing fertilizer envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films for three times till a coating rate reaches 2.1%, and solidifying for 3 to 5 minutes, so that the polyurethane controlled release films are solidified into the dense and tough fertilizer envelopes, namely, polyurethane envelopes on the surface of the fertilizer core particles; and
(4) adding the agglomerant in the above weight parts into the fertilizer core particles coated with the polyurethane envelopes for avoiding adhesion among the fertilizer core particles coated with the polyurethane envelopes, and cooling to 20° C., thus obtaining the controlled release fertilizer containing ammonium polyphosphate.

### Second Embodiment

A controlled release fertilizer containing ammonium polyphosphate according to a second embodiment of the present invention is provided. The controlled release fertilizer comprises fertilizer core particles and fertilizer envelopes coated on a surface of the fertilizer core particles respectively, wherein the controlled release fertilizer contains components in weight parts of:

| | |
|---|---|
| ammonium nitrate phosphate (30-6-0) | 400 parts; |
| ammonium polyphosphate | 150 parts; |
| potassium sulphate | 310 parts; |
| potassium calcium magnesium sulfate | 50 parts; |
| magnesium nitrate | 50 parts; |
| sodium borate | 3 parts; |
| ammonium molybdate | 3 parts; |
| EDTA (ethylenediaminetetraacetic acid) ferric salt and ferric chloride | 20 parts; |
| zinc nitrate | 0.5 part; |
| manganese nitrate | 1.5 parts; |
| copper nitrate and | 1 part; |
| an agglomerant | 11 parts, |

wherein ammonium polyphosphate has a degree of polymerization in a range of 5 to 20.

A preparation method of the above controlled release fertilizer containing ammonium polyphosphate comprises steps of:
(1) putting the above components except the agglomerant in the above weight parts into a pulverizer, pulverizing and obtaining powders by sieving through a sieve with a mesh number of 80;
(2) preparing fertilizer core particles, which comprises thoroughly mixing the powders obtained by the step (1) in a discal granulator, introducing atomized water into the discal granulator through a nozzle, pelletizing, screening, polishing and drying;
(3) preparing polyurethane envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films for three times till a coating rate reaches 2.0%, and solidifying for 3 to 5 minutes, so that the polyurethane controlled release films are solidified into the dense and tough fertilizer envelopes, namely, polyurethane envelopes on the surface of the fertilizer core particles; and
(4) adding the agglomerant in the above weight parts into the fertilizer core particles coated with the polyurethane envelopes for avoiding adhesion among the fertilizer core particles coated with the polyurethane envelopes, and cooling to 20° C., thus obtaining the controlled release fertilizer containing ammonium polyphosphate.

### Third Embodiment

A controlled release fertilizer containing ammonium polyphosphate according to a third embodiment of the present invention is provided. The controlled release fertilizer comprises fertilizer core particles and fertilizer envelopes coated on a surface of the fertilizer core particles respectively, wherein the controlled release fertilizer contains components in weight parts of:

| | |
|---|---|
| ammonium nitrate phosphate (30-6-0) | 450 parts; |
| ammonium polyphosphate | 200 parts; |
| potassium sulphate | 290 parts; |
| potassium calcium magnesium sulfate | 10 parts; |
| magnesium chloride | 75 parts; |
| boric acid | 1 part; |
| sodium molybdate | 1 part; |
| ferric chloride | 10 parts; |
| zinc chloride | 1 part; |
| manganese chloride | 2 parts; |
| copper chloride and | 1 part; |
| an agglomerant | 10 parts, |

wherein ammonium polyphosphate has a degree of polymerization in a range of 5 to 20.

A preparation method of the above controlled release fertilizer containing ammonium polyphosphate comprises steps of:
(1) putting the above components except the agglomerant in the above weight parts into a pulverizer, pulverizing and obtaining powders by sieving through a sieve with a mesh number of 80;
(2) preparing fertilizer core particles, which comprises thoroughly mixing the powders obtained by the step (1) in a discal granulator, introducing atomized water into the discal granulator through a nozzle, pelletizing, screening, polishing and drying;
(3) preparing polyurethane envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films for three times till a coating rate reaches 1.9%, and solidifying for 3 to 5 minutes, so that the polyurethane controlled release films are solidified into the dense and tough fertilizer envelopes, namely, polyurethane envelopes on the surface of the fertilizer core particles; and
(4) adding the agglomerant in the above weight parts into the fertilizer core particles coated with the polyurethane envelopes for avoiding adhesion among the fertilizer core particles coated with the polyurethane envelopes, and cooling to 20° C., thus obtaining the controlled release fertilizer containing ammonium polyphosphate.

### Fourth Embodiment

A controlled release fertilizer containing ammonium polyphosphate according to a fourth embodiment of the present invention is provided. The controlled release fertilizer comprises fertilizer core particles and fertilizer envelopes coated on a surface of the fertilizer core particles respectively, wherein the controlled release fertilizer contains components in weight parts of:

| | |
|---|---|
| ammonium nitrate phosphate (30-6-0) | 550 parts; |
| ammonium polyphosphate | 150 parts; |
| potassium sulphate | 150 parts; |
| potassium calcium magnesium sulfate | 10 parts; |
| magnesium chloride | 75 parts; |
| boric acid | 1 part; |
| sodium molybdate | 1 part; |
| ferric chloride | 10 parts; |
| zinc chloride | 1 part; |
| manganese chloride | 1.8 parts; |
| copper chloride and | 0.5 part; |
| an agglomerant | 5 parts, |

wherein ammonium polyphosphate has a degree of polymerization in a range of 5 to 20.

A preparation method of the above controlled release fertilizer containing ammonium polyphosphate comprises steps of:
(1) putting the above components except the agglomerant in the above weight parts into a pulverizer, pulverizing and obtaining powders by sieving through a sieve with a mesh number of 80;
(2) preparing fertilizer core particles, which comprises thoroughly mixing the powders obtained by the step (1) in a discal granulator, introducing atomized water into the discal granulator through a nozzle, pelletizing, screening, polishing and drying;
(3) preparing polyurethane envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films for three times till a coating rate reaches 2.0%, and solidifying for 3 to 5 minutes, so that the polyurethane controlled release films are solidified into the dense and tough fertilizer envelopes, namely, polyurethane envelopes on the surface of the fertilizer core particles; and
(4) adding the agglomerant in the above weight parts into the fertilizer core particles coated with the polyurethane envelopes for avoiding adhesion among the fertilizer core particles coated with the polyurethane envelopes, and cooling to 20° C., thus obtaining the controlled release fertilizer containing ammonium polyphosphate.

### Fifth Embodiment

A controlled release fertilizer containing ammonium polyphosphate according to a fifth embodiment of the present invention is provided. The controlled release fertilizer comprises fertilizer core particles and fertilizer envelopes coated on a surface of the fertilizer core particles respectively. Different from the first embodiment, the controlled release fertilizer contains components in weight parts of:

| | |
|---|---|
| ammonium nitrate phosphate (30-6-0) | 700 parts; |
| ammonium polyphosphate | 300 parts; |
| potassium sulphate | 450 parts; |
| potassium calcium magnesium sulfate | 30 parts; |
| magnesium sulfate | 100 parts; |
| boric acid | 2 parts; |
| sodium molybdate | 2 parts; |
| EDTA (ethylenediaminetetraacetic acid) ferric salt and ferric nitrate | 15 parts; |
| zinc sulfate | 1 part; |
| manganese sulfate | 2 parts; |
| copper sulfate and | 1 part; |
| an agglomerant | 30 parts, |

wherein ammonium polyphosphate has a degree of polymerization in a range of 5 to 20.

The preparation method of the above controlled release fertilizer according to the fifth embodiment of the present invention is the same as that according to the first embodiment.

### First Control Example

The fertilizer core particles, prepared by the step (2) of the preparation method according to the first embodiment of the present invention, are used as the fertilizer.

### Second Control Example

The fertilizer core particles, prepared by the step (2) of the preparation method according to the second embodiment of the present invention, are used as the fertilizer.

### Third Control Example

A common commercially available compound fertilizer is provided.

Application effects of the fertilizers according to the first, second, third and fourth embodiments and the first, second and third control examples of the present invention are as follows.

Experimental location: Shouguang City, Shandong Province, China.

Experimental period: from December 2021 to May 2022.

Pepper variety used in experiments: Haifeng No. 1.

Cultivation method: winter-greenhouse cultivation.

The nutrient and drug dosage of the first, second and third control examples and the first, second, third and fourth embodiments are the same, and the fertilizer dosage is 150 kg per mu (“mu” is Chinese unit of land measurement that is commonly 666.7 square meters). The commercially available compound fertilizer provided by the third control example is applied for four times, in which one third of the total compound fertilizer is applied to the bottom of the planting trench before transplanting, and the rest was evenly divided into three parts to be applied for three times respectively. The controlled release fertilizer containing ammonium polyphosphate according to the first and second control examples, and the first, second, third, fourth and fifth embodiments is one-time applied to the bottom of the planting trench before the pepper is transplanted. After the controlled release fertilizer is mixed with some soil, the seedlings are planted. The application effects are shown in Table 1.

TABLE 1

Application effects of the fertilizers according to the first, second, third and fourth embodiments and the first, second and third control examples

| | Increased Utilization of Phosphate Fertilizer (%) | Yield (kg/mu) | Cost Savings (yuan) |
|---|---|---|---|
| First Embodiment | 26.4 | 3698 | 474 |
| Second Embodiment | 27.6 | 3752 | 636 |
| Third Embodiment | 30.9 | 3827 | 861 |
| Fourth Embodiment | 29.1 | 3798 | 645 |
| First Control Example | 5.2 | 3580 | 123 |
| Second Control Example | 5.8 | 3592 | 157 |
| Third Control Example | - | 3540 | - |

Compared with the common commercially available compound fertilizer provided by the third control example, and the fertilizer core particles without fertilizer envelopes provided by the first and second control examples, the controlled release fertilizer containing ammonium polyphosphate provided by the first, second, third, fourth and fifth embodiments of the present invention has better application effects, which not only significantly improves the utilization rate of phosphate fertilizer, but also increases the yield of peppers, and accordingly, the cost-saving and efficiency-increasing per mu is remarkable. The fertilizer core particles of the controlled release fertilizer contain ammonium polyphosphate which is water-soluble, so after forming the polyurethane coating, the nutrient is slowly released from the polyurethane coating and sufficiently absorbed by plants. Therefore, the utilization rate of phosphate fertilizer is significantly improved. It is able to be seen from the embodiments of the present invention, the higher the content of ammonium polyphosphate in the fertilizer core particles, the higher the utilization rate of phosphate fertilizer. At the same time, ammonium polyphosphate and trace elements do not precipitate in the polyurethane coating, and the content of common trace elements is high and the solubility is good, the trace elements are also able to be slowly released from the polyurethane coating, and the nutrients are comprehensive, so the yield of peppers is increased significantly, which finally brings significant economic benefits to farmers. Moreover, the fertilizer is environmentally safe and pollution-free. Compared with the common commercially available compound fertilizer, the fertilizer core particles without fertilizer envelopes provided by the first and second control examples is still improved in application effects and the yield of peppers, but the application effects are able to be significantly improved after the fertilizer envelopes enwrapping the fertilizer core particles respectively.

The above is only some preferred embodiments of the present invention and is not intended to limit the present invention. Although the present invention is described in detail with reference to the aforementioned embodiments, for those skilled in the art, the technical schemes recorded in the aforementioned embodiments are still able to be modified, or some of the technical features are able to be replaced equally. Any modification, equivalent substitution, improvement, etc. made within the spirit and principles of the present invention shall be included in the protection scope of the present invention.

What is claimed is:

1. A controlled release fertilizer containing ammonium polyphosphate, wherein:
the controlled release fertilizer comprises fertilizer core particles and fertilizer envelopes coated on a surface of the fertilizer core particles respectively;
the fertilizer core particles contain phosphorus source, nitrogen source, potassium source and multiple metallic medium and trace element sources;
P (phosphorus) in the phosphorus source is only from ammonium polyphosphate which has a degree of polymerization in a range of 5 to 20 and has a chelating effect on metallic medium and trace elements in the multiple metallic medium and trace element sources.

2. The controlled release fertilizer according to claim 1, wherein the multiple metallic medium and trace element sources comprise calcium source, magnesium source, boron source, molybdenum source, iron source, zinc source, manganese source and copper source.

3. The controlled release fertilizer according to claim 1, wherein the controlled release fertilizer contains components in weight parts of:

| | |
|---|---|
| ammonium polyphosphate | 100-300 parts; |
| nitrogen source | 400-700 parts; |
| potassium source | 150-450 parts; |
| calcium source | 10-50 parts; |
| magnesium source | 50-100 parts; |
| boron source | 1-3 parts; |
| molybdenum source | 1-3 parts; |
| iron source | 5-20 parts; |
| zinc source | 0.5-1 part; |
| manganese source | 1.5-2 parts; |
| copper source and | 0.5-1 part; |
| an agglomerant | 5-30 parts. |

4. The controlled release fertilizer according to claim 3, wherein the nitrogen source is ammonium nitrate phosphate, and the potassium source is potassium sulfate.

5. The controlled release fertilizer according to claim 4, wherein:
the calcium source is potassium calcium magnesium sulfate;
the magnesium source is at least one member selected from a group consisting of magnesium sulfate, magnesium nitrate and magnesium chloride.

6. The controlled release fertilizer according to claim 4, wherein:
the boron source is at least one member selected from a group consisting of boric acid and sodium borate salt;
the molybdenum source is at least one member selected from a group consisting of sodium molybdate and ammonium molybdate.

7. The controlled release fertilizer according to claim 4, wherein:
the iron source is a mixture of EDTA (ethylenediaminetetraacetic acid) ferric salt and ferric nitrate, a mixture of EDTA ferric salt and ferric chloride, ferric nitrate or ferric chloride;
the zinc source is at least one member selected from a group consisting of zinc sulfate, zinc nitrate and zinc chloride.

8. The controlled release fertilizer according to claim 4, wherein:
the manganese source is at least one member selected from a group consisting of manganese sulfate, manganese nitrate and manganese chloride;
the copper source is copper sulfate, copper nitrate or copper chloride.

9. The controlled release fertilizer according to claim 1, wherein the fertilizer envelopes are polyurethane envelopes.

10. A preparation method of the controlled release fertilizer according to claim 9, wherein the preparation method comprises steps of:
(1) weighing the phosphorus source, the nitrogen source, the potassium source and the multiple metallic medium and trace element sources in the above weight parts, pulverizing, and obtaining powders by sieving through a sieve with a mesh number of 80;
(2) preparing fertilizer core particles, which comprises thoroughly mixing the powders obtained by the step (1) in a granulator, introducing atomized water into the granulator through a nozzle, pelletizing, screening, polishing and drying;
(3) preparing fertilizer envelopes on a surface of the fertilizer core particles respectively, which comprises putting the fertilizer core particles into a sugarcoating machine, heating at 55-65° C., preparing a coating material by mixing polymerized MDI (diphenyl methane diisocyanate) with vegetable oil-based polyester polyols, coating the coating material on the surface of the fertilizer core particles, forming polyurethane controlled release films by a cross-linking reaction between the coating material and the surface of the fertilizer core particles for increasing viscosity, repeating steps of preparing and coating the coating material and forming the polyurethane controlled release films till a coating rate is in a range of 1.9%-2.1%, and solidifying for 3 to 5 minutes, so that the polyurethane controlled release films are solidified into the fertilizer envelopes on the surface of the fertilizer core particles; and
(4) adding the agglomerant in the above weight parts into the fertilizer core particles coated with the fertilizer envelopes, and cooling to 20° C., thus obtaining the controlled release fertilizer containing ammonium polyphosphate.
